(19) United States
(12) Patent Application Publication
(10) Pub. No.: US 2026/0329057 A1
(43) Pub. Date: Oct. 22, 2026

(54) IMAGING LENS ASSEMBLY MODULE AND ELECTRONIC DEVICE

(71) Applicant: LARGAN DIGITAL CO., LTD., Taichung City (TW)

(72) Inventors: Hao-Jan CHEN, Taichung City (TW); Chen-Wei FAN, Taichung City (TW)

(21) Appl. No.: 19/632,495

(22) Filed: Mar. 30, 2026

(30) Foreign Application Priority Data
Apr. 17, 2025 (TW) 114114671

(51) Int. Cl. G02B 13/00

(52) U.S. Cl. CPC G02B 13/0065

(57) ABSTRACT

An imaging lens assembly module includes an optical folding element and a driving module. The optical folding element has a reflecting surface, a light is incident to the optical folding element along a first optical axis, and the light exits the optical folding element along a second optical axis after reflecting at the reflecting surface. The driving module includes a first carrier, a first magnet, first rolling elements, a second carrier and a second rolling element. The first carrier is disposed on a frame. The first magnet is configured to form a driving force with a first coil and drive the first carrier. The first rolling elements are disposed between the frame and the first carrier. The second carrier is disposed on the first carrier. The second rolling element is disposed between the first carrier and the second carrier.

### RELATED APPLICATIONS

This application claims priority to Taiwan Application Serial Number 114114671, filed Apr. 17, 2025, which is herein incorporated by reference.

### BACKGROUND

### Technical Field

The present disclosure relates to an imaging lens assembly module. More particularly, the present disclosure relates to an imaging lens assembly module applicable to portable electronic devices.

### Description of Related Art

In recent years, portable electronic devices have developed rapidly. For example, intelligent electronic devices and tablets have been filled in the lives of modern people, and imaging lens assembly modules mounted on portable electronic devices have also prospered. However, as technology advances, the quality requirements of the imaging lens assembly module are becoming higher and higher. Therefore, an imaging lens assembly module, which can enhance the imaging quality, needs to be developed.

### SUMMARY

The present disclosure provides an imaging lens assembly module, which includes an optical folding element and a driving module. The optical folding element has a reflecting surface, a light is incident to the optical folding element along a first optical axis, the light exits the optical folding element along a second optical axis after reflecting at the reflecting surface, and the first optical axis and the second optical axis intersect at an optical axis intersection point on the reflecting surface. The driving module is configured to drive the optical folding element to rotate, and includes a first carrier, a first magnet, at least two first rolling elements, a second carrier and a second rolling element. The first carrier is disposed on a frame, the first carrier is rotatable around a first rotating axis relative to the frame, and the first rotating axis is vertical to the first optical axis and passes through the optical axis intersection point. The first magnet is configured to form a driving force with a first coil and drive the first carrier. The first rolling elements are disposed between the frame and the first carrier and configured to support the first carrier to rotate. The second carrier is disposed on the first carrier, and the optical folding element is disposed on the second carrier. The second rolling element is disposed between the first carrier and the second carrier and configured to support the second carrier to rotate. The second carrier is rotatable around a second rotating axis relative to the first carrier, and the second rotating axis is vertical to the first rotating axis.

According to one aspect of the present disclosure, an electronic device includes the imaging lens assembly module of the aforementioned aspect.

### BRIEF DESCRIPTION OF THE DRAWINGS

FIG. 1A is a three-dimensional view of an imaging lens assembly module according to the 1st example of the present disclosure.

FIG. 1B is a cross-sectional view of the imaging lens assembly module according to the 1st example in FIG. 1A.

FIG. 1C is an exploded view of the imaging lens assembly module according to the 1st example in FIG. 1A.

FIG. 1D is an exploded view of the driving module, the optical folding element and the frame according to the 1st example in FIG. 1A.

FIG. 1E is another exploded view of the driving module, the optical folding element and the frame according to the 1st example in FIG. 1A.

FIG. 1F is a schematic view of the first carrier rotatable around the first rotating axis according to the 1st example in FIG. 1A.

FIG. 1G is a cross-sectional view in FIG. 1F.

FIG. 1H is a schematic view of the first rolling elements, the second rolling element, the first magnet and the first yoke as viewed along the first rotating axis.

FIG. 1I is another cross-sectional view in FIG. 1F.

FIG. 1J is a schematic view of the second carrier rotatable around the second rotating axis according to the 1st example in FIG. 1A.

FIG. 1K is a cross-sectional view in FIG. 1J.

FIG. 1L is a schematic view of the second magnet according to the 1st example in FIG. 1A.

FIG. 1M is a schematic view of the contact points between the first carrier and the third rolling elements in FIG. 1K.

FIG. 1N is a schematic view of the second yoke and the third magnet according to the 1st example in FIG. 1A.

FIG. 2A is an exploded view of a driving module, an optical folding element and a frame of an imaging lens assembly module according to the 2nd example of the present disclosure.

FIG. 2B is a three-dimensional view of a second magnet in FIG. 2A.

FIG. 2C is a schematic view of a second coil, the second magnet and a first rotating axis of the imaging lens assembly module in FIG. 2A.

FIG. 3 is a schematic view of a first carrier, a second carrier, a second yoke and a first magnet of an imaging lens assembly module according to the 3rd example of the present disclosure.

FIG. 4A is a schematic view of an electronic device according to the 4th example of the present disclosure.

FIG. 4B is another schematic view of the electronic device according to the 4th example in FIG. 4A.

FIG. 4C is a schematic view of an image captured via the electronic device according to the 4th example in FIG. 4A.

FIG. 4D is another schematic view of an image captured via the electronic device according to the 4th example in FIG. 4A.

FIG. 4E is another schematic view of an image captured via the electronic device according to the 4th example in FIG. 4A.

FIG. 5 is a schematic view of an electronic device according to the 5th example of the present disclosure.

### DETAILED DESCRIPTION

The present disclosure provides an imaging lens assembly module, which includes an optical folding element and a driving module, wherein the driving module is configured to drive the optical folding element to rotate. The optical folding element has a reflecting surface, a light is incident to the optical folding element along a first optical axis, the light exits the optical folding element along a second optical axis after reflecting at the reflecting surface, and the first optical axis and the second optical axis intersect at an optical axis intersection point on the reflecting surface. The driving module includes a first carrier, a first magnet, at least two first rolling elements, a second carrier and a second rolling element. The first carrier is disposed on a frame, the first carrier is rotatable around a first rotating axis relative to the frame, and the first rotating axis is vertical to the first optical axis and passes through the optical axis intersection point. The first magnet is configured to form a driving force with a first coil and drive the first carrier. The first rolling elements are disposed between the frame and the first carrier and configured to support the first carrier to rotate. The second carrier is disposed on the first carrier, and the optical folding element is disposed on the second carrier. The second rolling element is disposed between the first carrier and the second carrier and configured to support the second carrier to rotate. The second carrier is rotatable around a second rotating axis relative to the first carrier, and the second rotating axis is vertical to the first rotating axis. Therefore, the first carrier can rotate in pitch, and the second carrier can rotate in yaw relative to the first carrier so that the optical folding element has two rotational degrees of freedom.

The first carrier is simultaneously configured to carry the second carrier and the optical folding element so as to obtain the higher loading, and the optical axis can be folded by 2 degrees by the reflecting surface rotating in pitch around the first rotating axis by 1 degree. Therefore, the rotating angle can be reduced by the first carrier rotating in pitch compared to the first carrier rotating in yaw, so that the electricity can be saved, wherein the first carrier is high-loading. In particular, the first carrier and the second carrier are rotatable around the optical axis intersection point as the rotating center.

The first rolling elements and the optical axis intersection point can be coaxially disposed along the first rotating axis. Therefore, the position of the optical axis intersection point can be fixed during the driving module rotating in pitch so as to reduce the difficulty of the driving control.

The second rolling element and the optical axis intersection point can be coaxially disposed along the second rotating axis. Therefore, the position of the optical axis intersection point can be fixed during the driving module rotating in yaw so as to reduce the difficulty of the driving control.

The first rolling elements and the first magnet can be disposed along the second rotating axis as viewed along the first rotating axis. Therefore, the rotating torque can be effectively formed via the driving force of the first magnet.

The driving module can further include a first yoke fixed on the frame, the first yoke and the first magnet are correspondingly disposed, and the first yoke and the first magnet attract to each other to provide a preload force to the first carrier. The first rolling elements, the first magnet and the first yoke are disposed in sequence along the second rotating axis as viewed along the first rotating axis. Therefore, the first magnet can simultaneously obtain the function of providing the driving force and assembling the preload force. Furthermore, the first magnet and the first yoke are disposed along the first optical axis so as to avoid the torque formed via the preload force, so that the first carrier can be maintained the stable posture thereof when no power is applied. In detail, the preload force is the assembly bonding force of the first carrier disposed on the frame so as to maintain the bonding status between the first carrier and the frame.

The first rolling elements, the second rolling element and the first magnet can be disposed in sequence along the second rotating axis as viewed along the first rotating axis. Therefore, the stable posture of the driving module can be maintained.

The first rolling elements can be farther away from the first magnet relative to the second rolling element as viewed along the first rotating axis. Therefore, the first magnet can have the longer driving force arm.

The driving module can further include at least two third rolling elements disposed between the first carrier and the second carrier and configured to support the second carrier to rotate, and the third rolling elements are disposed around the second rolling element as a center. Therefore, the rotation of the second carrier is assisted so as to enhance the rotating stability.

Each of the third rolling elements and the second carrier can be in two-point contact. Therefore, the rotating accuracy can be avoided being influenced by over-positioning.

Each of the third rolling elements and the first carrier can be in three-point contact. Therefore, the balance between the positioning and the rotating accuracy can be achieved.

A distance between each two of the first rolling elements, the second rolling element and the third rolling elements can be fixed. Therefore, the structural stability of the driving module can be maintained during the driving process.

The driving module can further include a second magnet configured to drive the second carrier to rotate, wherein the second magnet has four polarities. Therefore, the stability of the magnetic field can be enhanced.

The second magnet can be arc-shaped, and the second magnet is centered on the first rotating axis. Therefore, the distribution of the magnetic field between the second magnet and the second coil can be maintained after the first carrier rotates so as to enhance the stability of the driving force.

The driving module can further include a second yoke disposed on the second carrier, and the second yoke and the first magnet attract to each other to provide a preload force to the second carrier. Therefore, not only can provide the driving force of the first carrier, but the first magnet can also provide the function of the assembling preload force between the first carrier and the second carrier.

Or, the second yoke is disposed on the second carrier, and the second yoke and a third magnet attract to each other to provide a preload force to the second carrier. Therefore, the bonding status between the second carrier and the first carrier can be maintained.

The second yoke can be disposed in the second carrier. Therefore, the volume can be reduced, and the structural strength of the second carrier can be enhanced. In particular, the second yoke can be embedded in the second carrier by the insert molding, but the present disclosure is not limited thereto.

The imaging lens assembly module can further include a lens assembly disposed on the frame, and the lens assembly moves along the second optical axis relative to the frame. Therefore, the frame can be simultaneously disposed on the driving module and the lens assembly so as to reduce the assembling process.

The imaging lens assembly module can further include at least two fourth rolling elements configured to support the lens assembly to move. Therefore, the lens assembly can obtain the focusing function or the zooming function.

The present disclosure provides an electronic device, which includes the aforementioned imaging lens assembly module.

### 1st Example

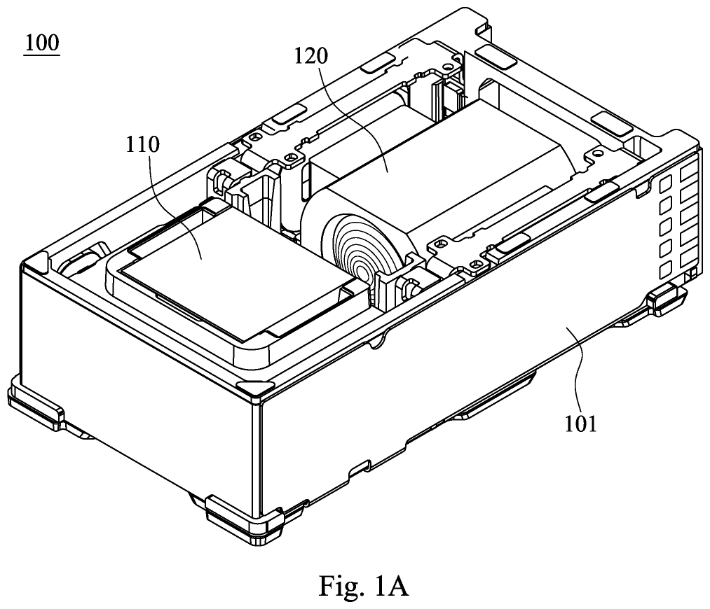

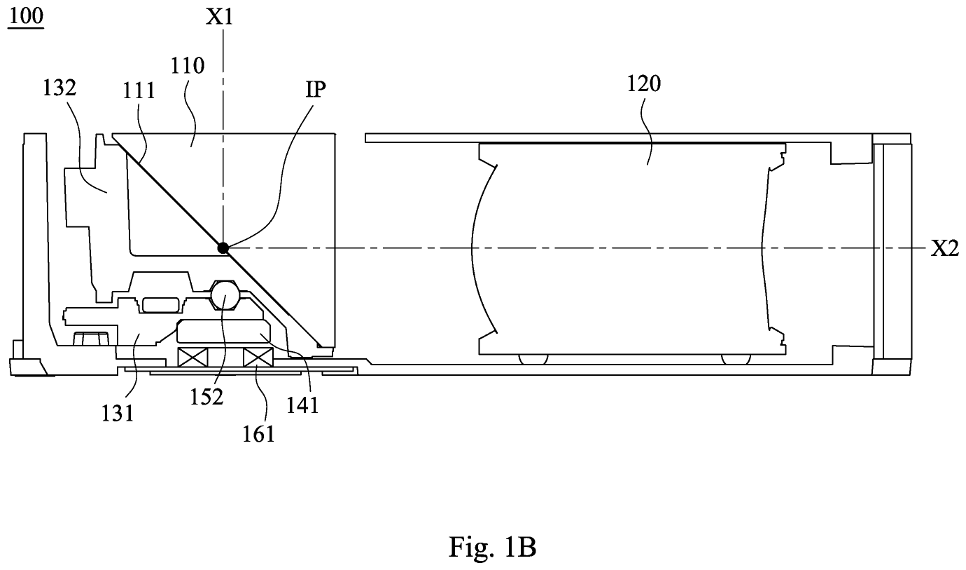

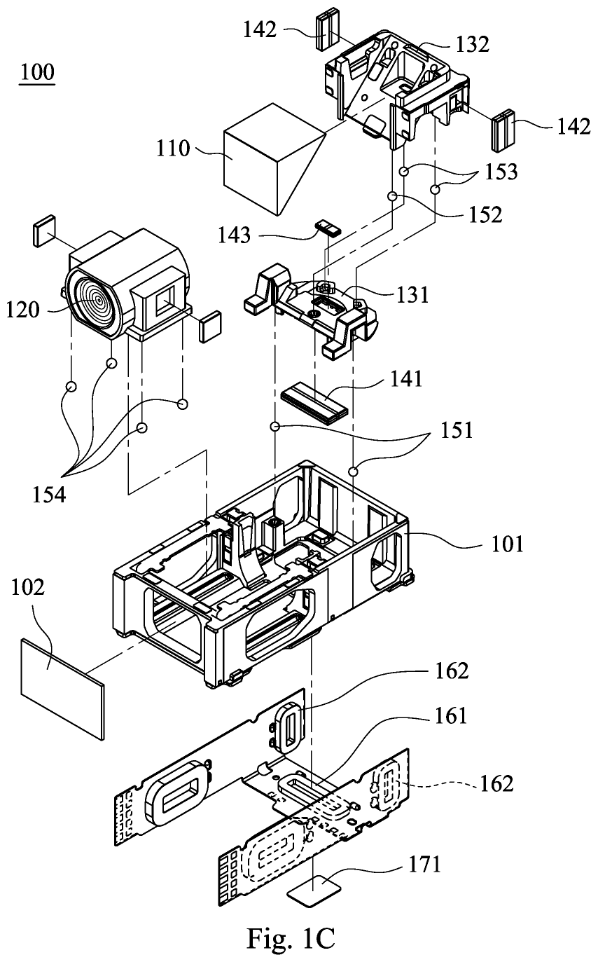

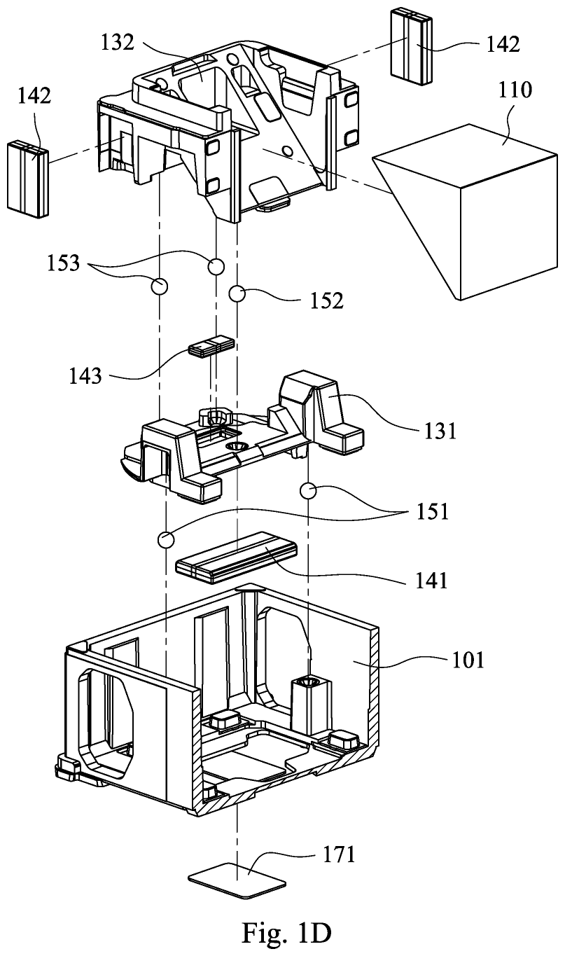

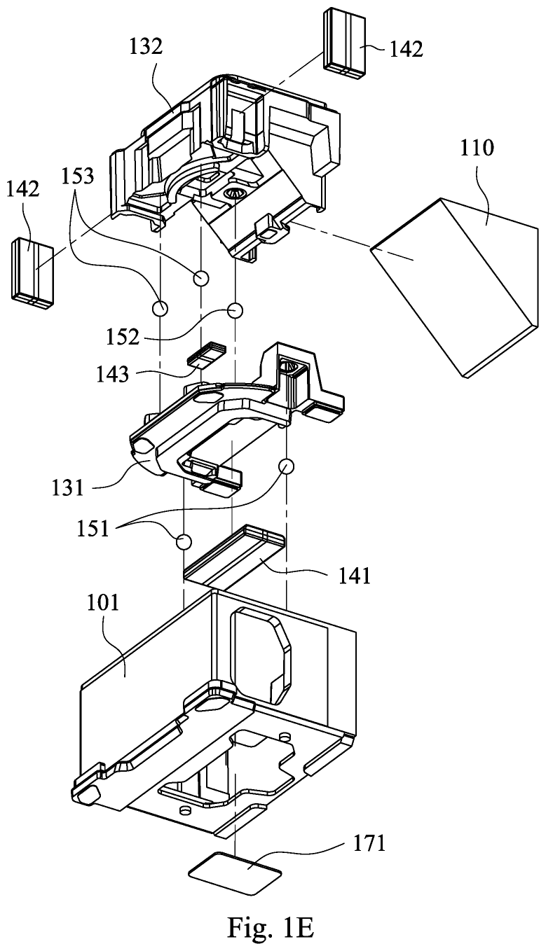

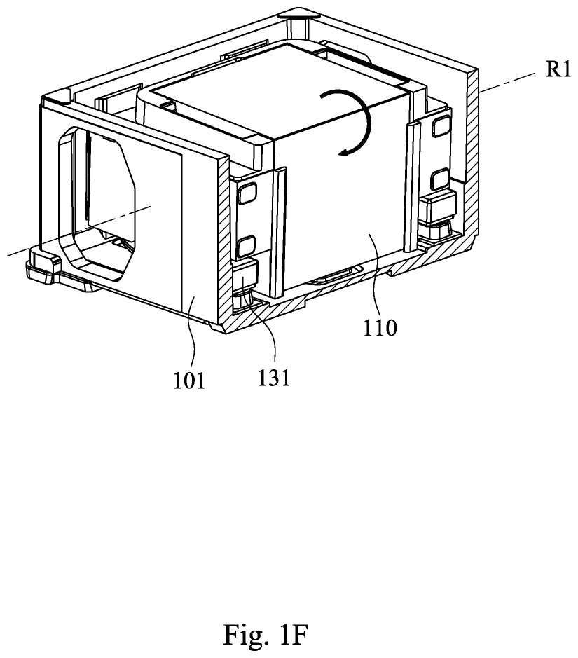

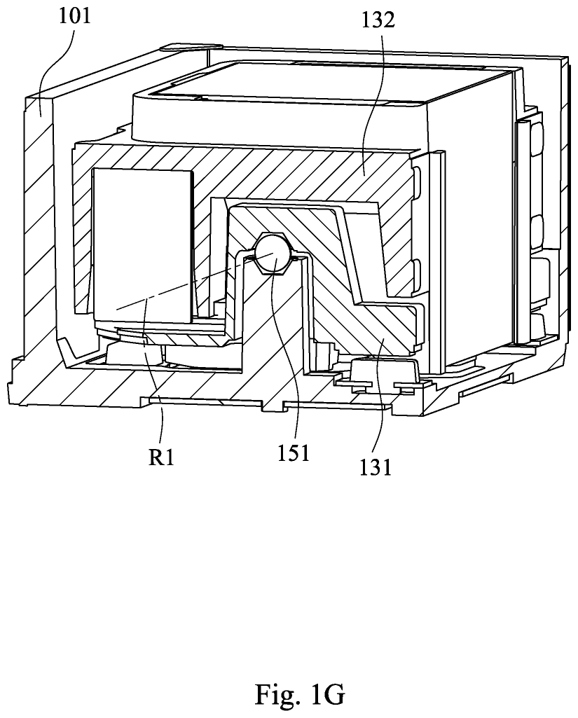

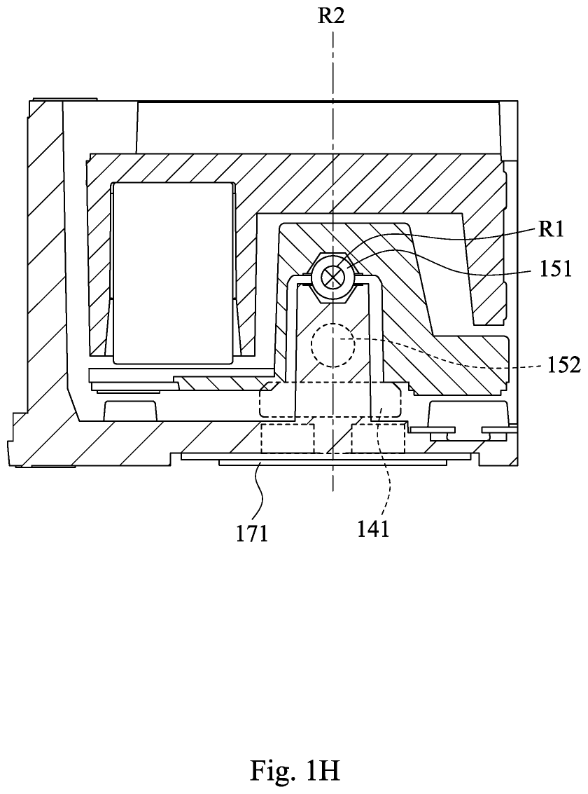

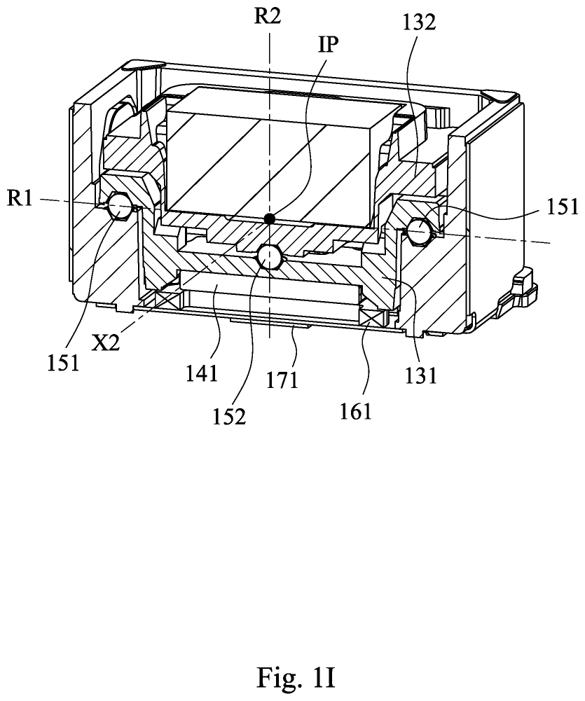

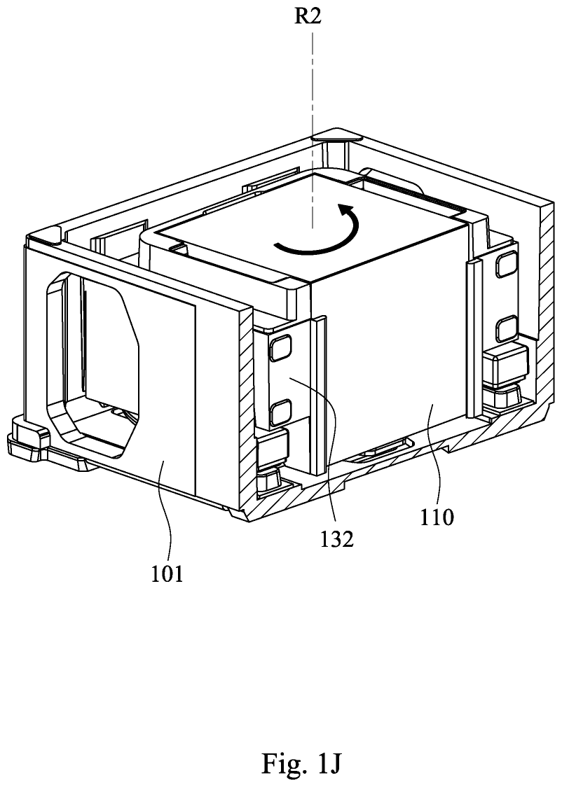

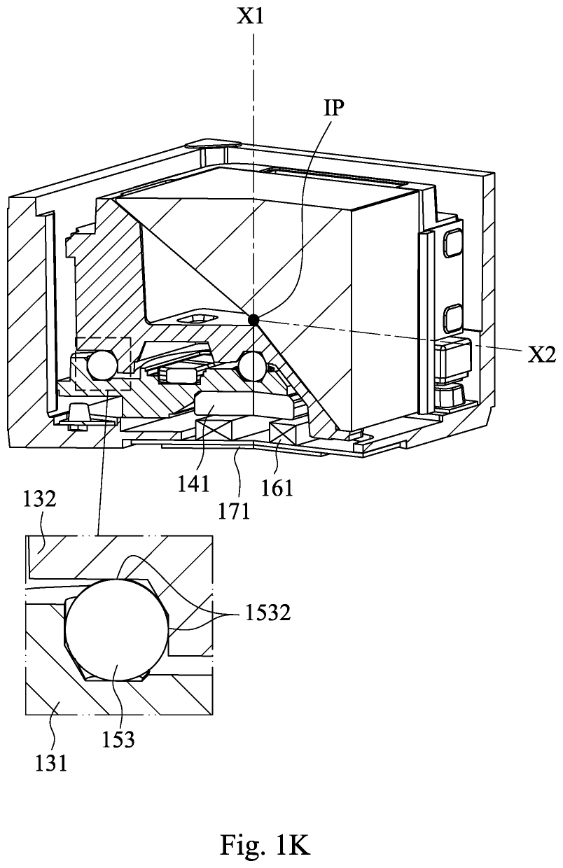

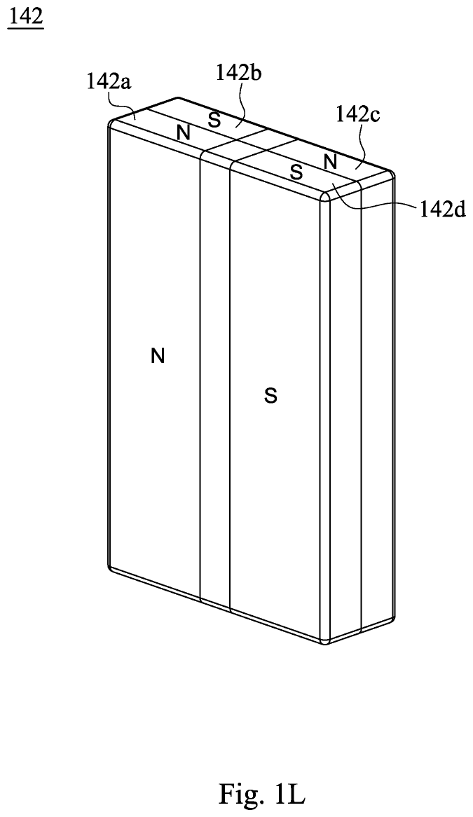

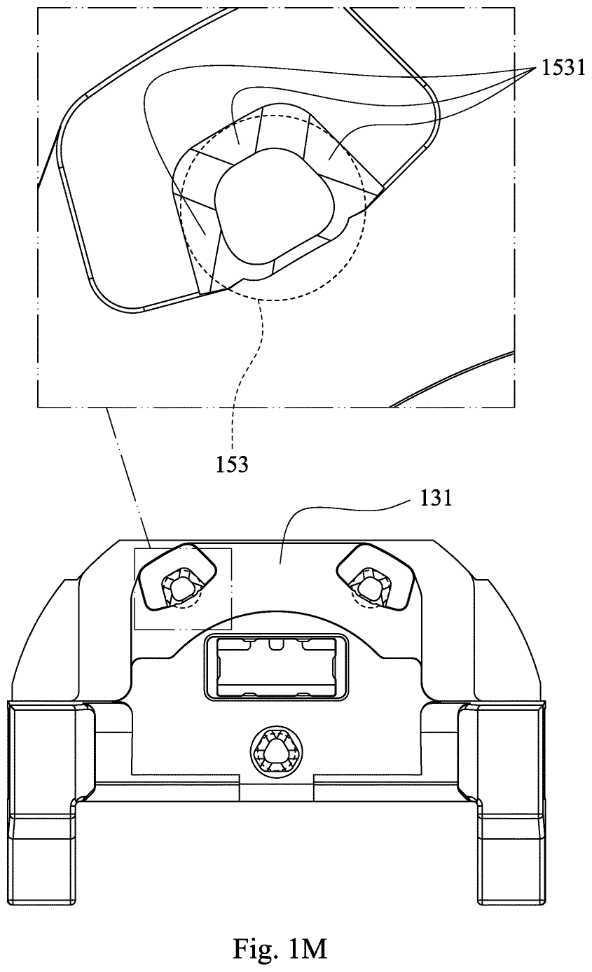

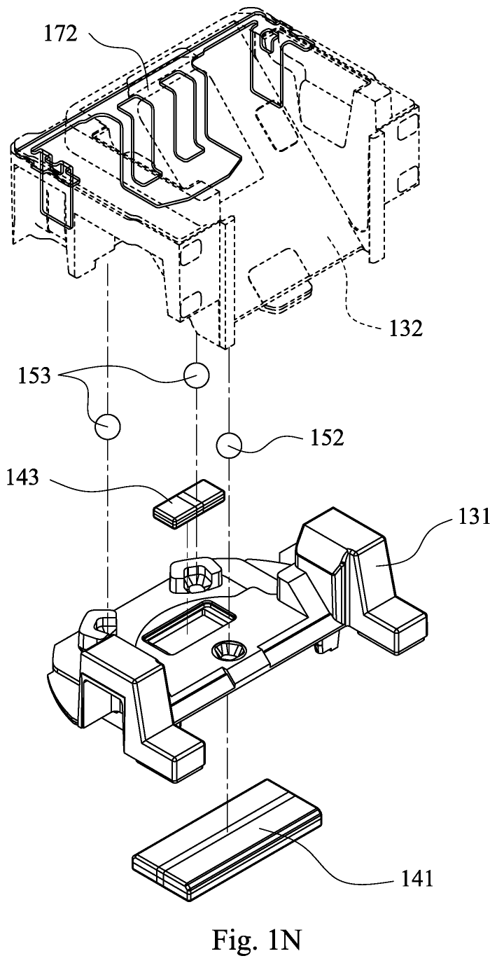

FIG. 1A is a three-dimensional view of an imaging lens assembly module 100 according to the 1st example of the present disclosure. FIG. 1B is a cross-sectional view of the imaging lens assembly module 100 according to the 1st example in FIG. 1A. FIG. 1C is an exploded view of the imaging lens assembly module 100 according to the 1st example in FIG. 1A. In FIGS. 1A to 1C, the imaging lens assembly module 100 includes a frame 101, an optical folding element 110, a lens assembly 120, a driving module (its reference numeral is omitted) and an image sensor 102, wherein the optical folding element 110, the lens assembly 120 and the image sensor 102 are disposed on the frame 101 along an object side to an image side of the imaging lens assembly module 100, and the driving module is disposed on the frame 101 so as to make the optical folding element 110 rotate. The optical folding element 110 has a reflecting surface 111, a light is incident to the optical folding element 110 along a first optical axis X1, the light exits the optical folding element 110 along a second optical axis X2 after reflecting at the reflecting surface 111, and the first optical axis X1 and the second optical axis X2 intersect at an optical axis intersection point IP on the reflecting surface 111. The light is incident to the optical folding element 110 along the first optical axis X1, and then the light is folded to pass through the lens assembly 120 and be incident to the image sensor 102 along the second optical axis X2 via the reflecting surface 111.

FIG. 1D is an exploded view of the driving module, the optical folding element 110 and the frame 101 according to the 1st example in FIG. 1A. FIG. 1E is another exploded view of the driving module, the optical folding element 110 and the frame 101 according to the 1st example in FIG. 1A. In FIGS. 1B to 1D, the driving module includes a first carrier 131, a first magnet 141, two first rolling elements 151, a second carrier 132 and a second rolling element 152. The first carrier 131 is disposed on a frame 101, the second carrier 132 is disposed on the first carrier 131, and the optical folding element 110 is disposed on the second carrier 132. The first magnet 141 is disposed on the frame 101, and the first rolling elements 151 are disposed between the frame 101 and the first carrier 131.

FIG. 1F is a schematic view of the first carrier 131 rotatable around the first rotating axis R1 according to the 1st example in FIG. 1A. FIG. 1G is a cross-sectional view in FIG. 1F. FIG. 1H is a schematic view of the first rolling elements 151, the second rolling element 152, the first magnet 141 and the first yoke 171 as viewed along the first rotating axis R1. The first carrier 131 can rotate in pitch relative to the frame 101 around the first rotating axis R1, so that the optical folding element 110 is rotatable around the first rotating axis R1. The first rotating axis R1 is vertical to the first optical axis X1 and passes through the optical axis intersection point IP. The first magnet 141 is configured to form a driving force with a first coil 161 and drive the first carrier 131. The first rolling elements 151 are configured to support the first carrier 131 to rotate.

The driving module can further include a first yoke 171 fixed on the frame 101, the first yoke 171 and the first magnet 141 are correspondingly disposed, and the first yoke 171 and the first magnet 141 attract to each other to provide a preload force to the first carrier 131.

FIG. 1I is another cross-sectional view in FIG. 1F. FIG. 1J is a schematic view of the second carrier 132 rotatable around the second rotating axis R2 according to the 1st example in FIG. 1A. FIG. 1K is a cross-sectional view in FIG. 1J. The second carrier 132 can rotate in yaw relative to the first carrier 131 around the second rotating axis R2 (that is, the first optical axis X1), so that the optical folding element 110 is rotatable around the second rotating axis R2, wherein the second rotating axis R2 is vertical to the first rotating axis R1. The second rolling element 152 is disposed between the first carrier 131 and the second carrier 132 so as to support the second carrier 132 to rotate.

The driving module can further include two second magnets 142 disposed on two sides of the second carrier 132, the second magnets 142 are disposed on the second coil 162 of the frame 101, respectively, and the second magnets 142 are configured to drive the second carrier 132 to rotate. FIG. 1L is a schematic view of the second magnet 142 according to the 1st example in FIG. 1A. In FIG. 1L, the second magnet 142 has four polarities 142a, 142b, 142c, 142d, and the polarities 142a, 142b, 142c, 142d are adjacent and different so as to form the second magnets 142.

In FIGS. 1H and 1I, the first rolling elements 151, the second rolling element 152 and the first magnet 141 are disposed in sequence along a direction parallel to the first optical axis X1 (that is, parallel to the second rotating axis R2) as viewed along the first rotating axis R1. Further, the first rolling elements 151 are farther away from the first magnet 141 relative to the second rolling element 152. The first rolling elements 151 and the optical axis intersection point IP are coaxially disposed along the first rotating axis R1. The second rolling element 152 and the optical axis intersection point IP are coaxially disposed along the second rotating axis R2.

FIG. 1M is a schematic view of the contact points 1531 between the first carrier 131 and the third rolling elements 153 in FIG. 1K. FIG. 1N is a schematic view of the second yoke 172 and the third magnet 143 according to the 1st example in FIG. 1A. The driving module can further include two third rolling elements 153, the second yoke 172 and the third magnet 143. The third rolling elements 153 are disposed between the first carrier 131 and the second carrier 132 and configured to support the second carrier 132 to rotate, and the third rolling elements 153 are disposed around the second rolling element 152 as a center. The second yoke 172 is disposed on the second carrier 132, and the second yoke 172 and the third magnet 143 disposed on the first carrier 131 attract to each other to provide a preload force to the second carrier 132. Therefore, the second carrier 132 can be assembled with the first carrier 131 via the attraction between the second yoke 172 and the third magnet 143. In particular, the second yoke 172 is disposed in the second carrier 132. According to the 1st example of FIG. 1N, the second yoke 172 can be embedded in the second carrier 132 by the insert molding, but the present disclosure is not limited thereto.

In FIGS. 1K and 1M, each of the third rolling elements 153 and the first carrier 131 are in three-point contact, which means three contact points 1531, and each of the third rolling elements 153 and the second carrier 132 are in two-point contact, which means two contact points 1532.

In FIG. 1C, the imaging lens assembly module 100 can further include four fourth rolling elements 154 disposed between the lens assembly 120 and the frame 101 and configured to support the lens assembly 120 to move.

### 2nd Example

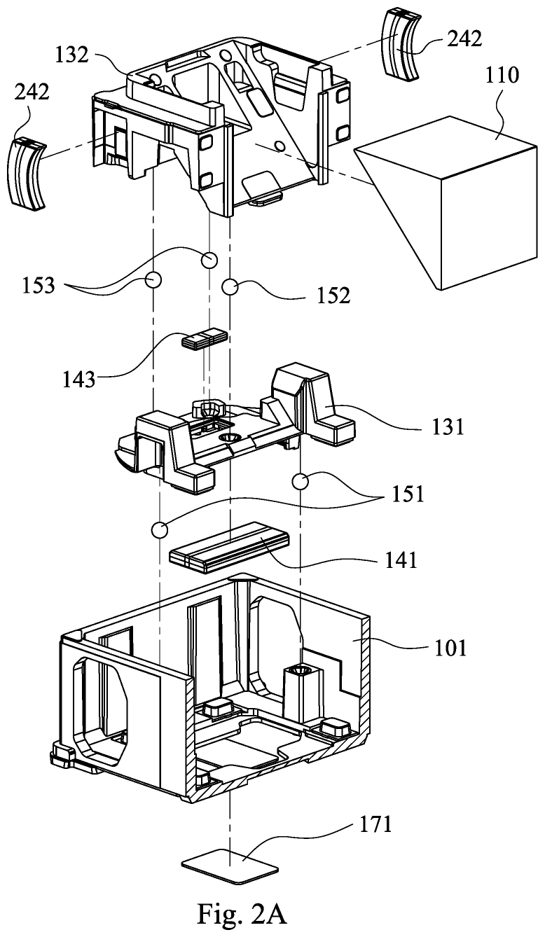

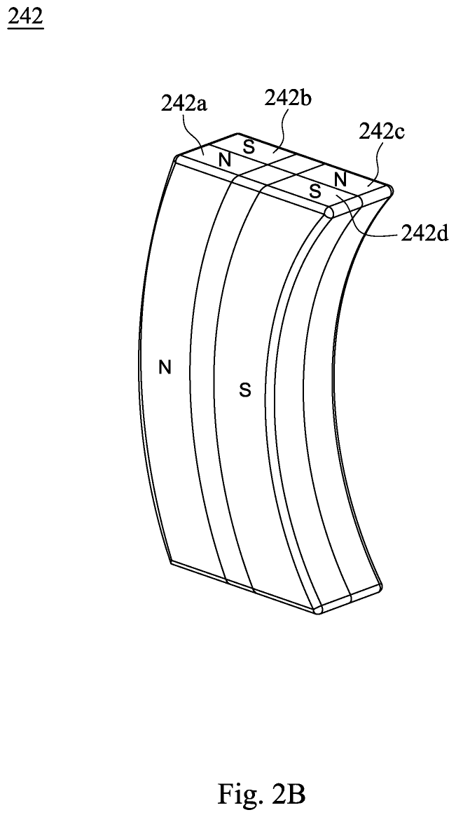

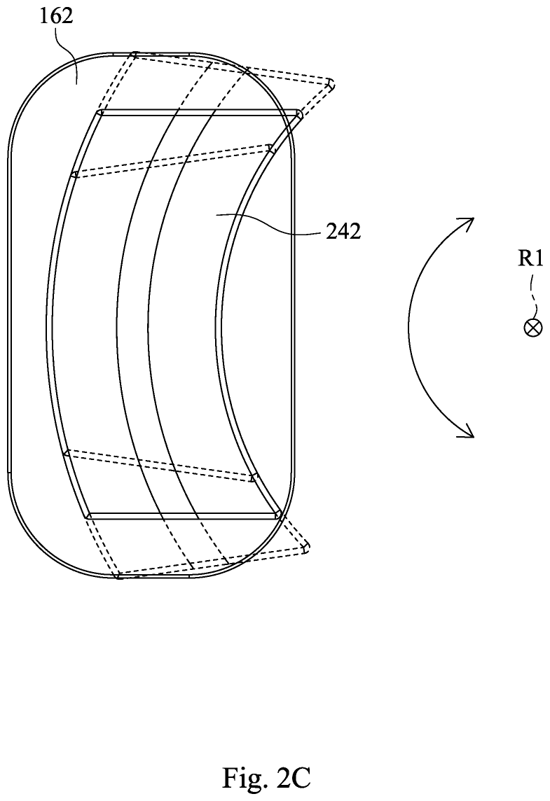

FIG. 2A is an exploded view of a driving module (its reference numeral is omitted), an optical folding element 110 and a frame 101 of an imaging lens assembly module (its reference numeral is omitted) according to the 2nd example of the present disclosure. FIG. 2B is a three-dimensional view of a second magnet 242 in FIG. 2A. FIG. 2C is a schematic view of a second coil 162, the second magnet 242 and a first rotating axis R1 of the imaging lens assembly module in FIG. 2A.

In FIGS. 2A to 2C, the main difference between the imaging lens assembly module according to the 2nd example and the imaging lens assembly module 100 according to the 1st example is that the second magnets 242 according to the 2nd example is different from the second magnet 142 according to the 1st example. In particular, the second magnets 242 according to the 2nd example are arc-shaped, and the second magnets 242 are centered on the first rotating axis R1. In detail, the second magnets 242 are arc-shaped, which is centered on the first rotating axis R1, so that the distribution of the magnetic field of the second coil 162 can be maintained after the second magnets 242 rotates in pitch. In FIG. 2B, each of the second magnets 242 has four polarities 242a, 242b, 242c, 242d, and the polarities 242a, 242b, 242c, 242d are adjacent and different so as to form the second magnets 242.

It should be mentioned that all of other structures and dispositions according to the 2nd example are the same as the structures and the dispositions according to the 1st example, the elements in FIGS. 2A and 2C same or similar to the elements according to the 1st example are labelled by the same reference numerals, and the connection and the operation relationship thereof will not be described again herein.

### 3rd Example

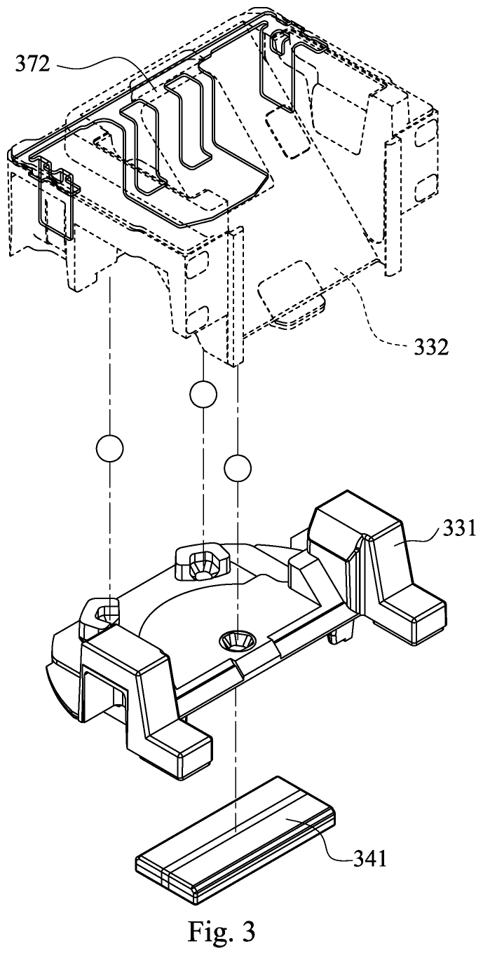

FIG. 3 is a schematic view of a first carrier 331, a second carrier 332, a second yoke 372 and a first magnet 341 of an imaging lens assembly module (its reference numeral is omitted) according to the 3rd example of the present disclosure. In FIG. 3, the main difference between the imaging lens assembly module according to the 3rd example and the imaging lens assembly module 100 according to the 1st example is that the second carrier 332 according to the 3rd example and the first magnet 341 disposed on the first carrier 331 attract to each other via the second yoke 372 disposed in the second carrier 332 so as to provide the preload force to the second carrier 332, so that the second carrier 332 can be combined with the first carrier 331.

In particular, the second yoke 372 can be embedded in the second carrier 332 by the insert molding, but the present disclosure is not limited thereto.

Further, all of other structures and dispositions according to the 3rd example are the same as the structures and the dispositions according to the 1st example, and will not be described again herein.

### 4th Example

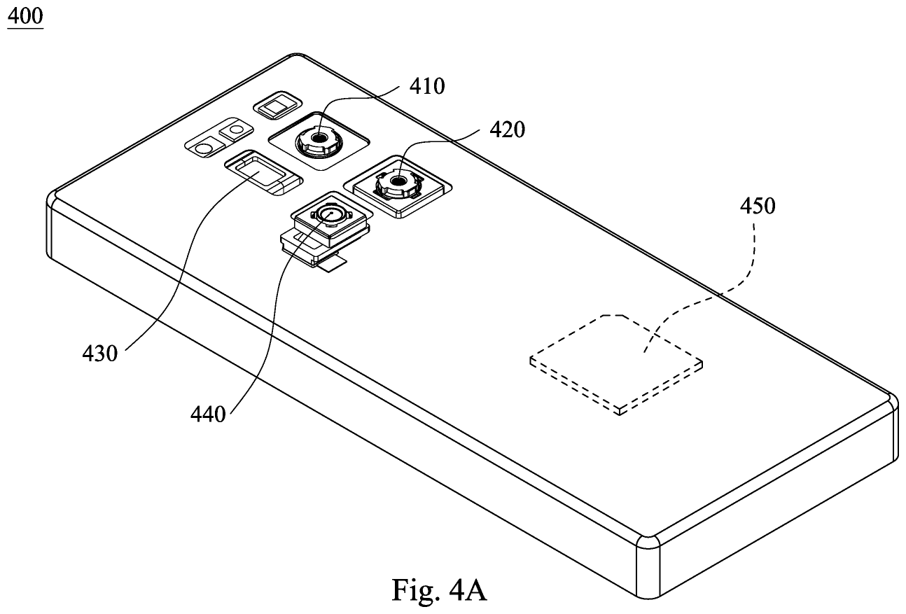

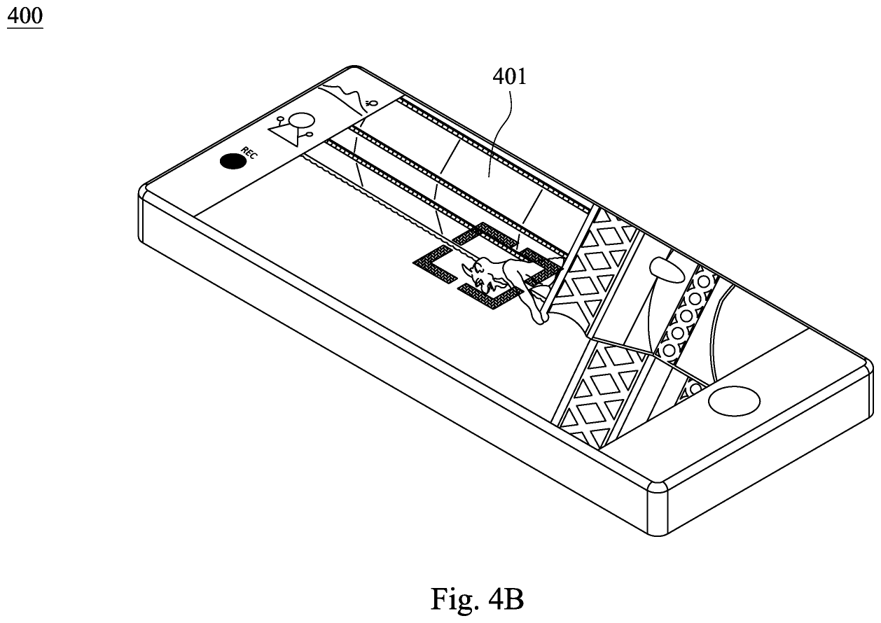

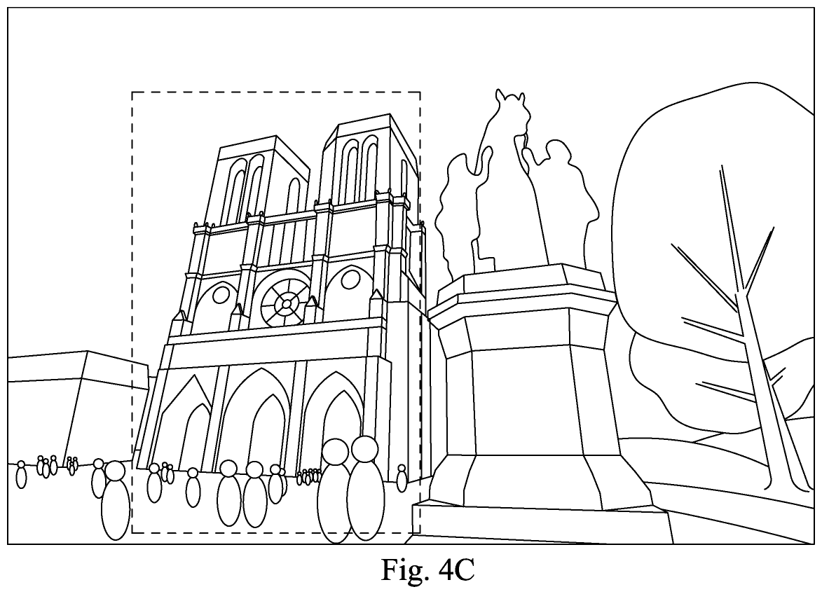

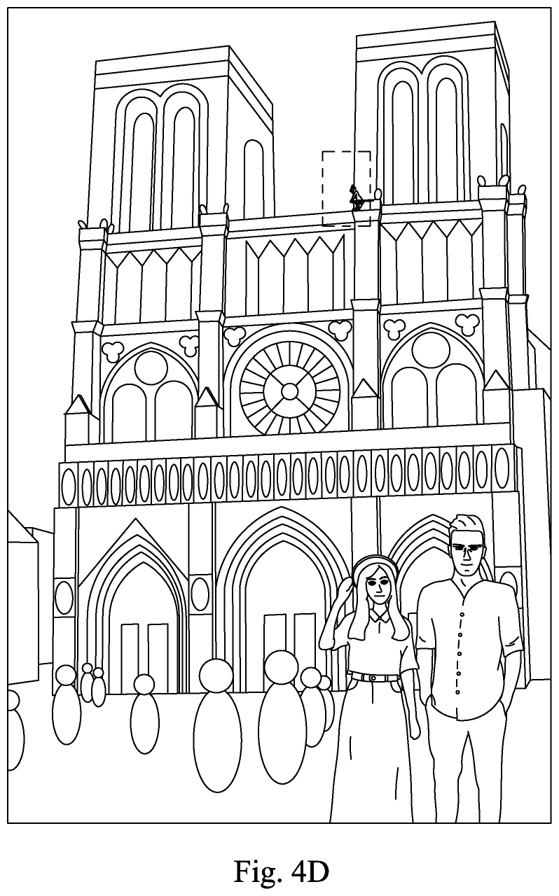

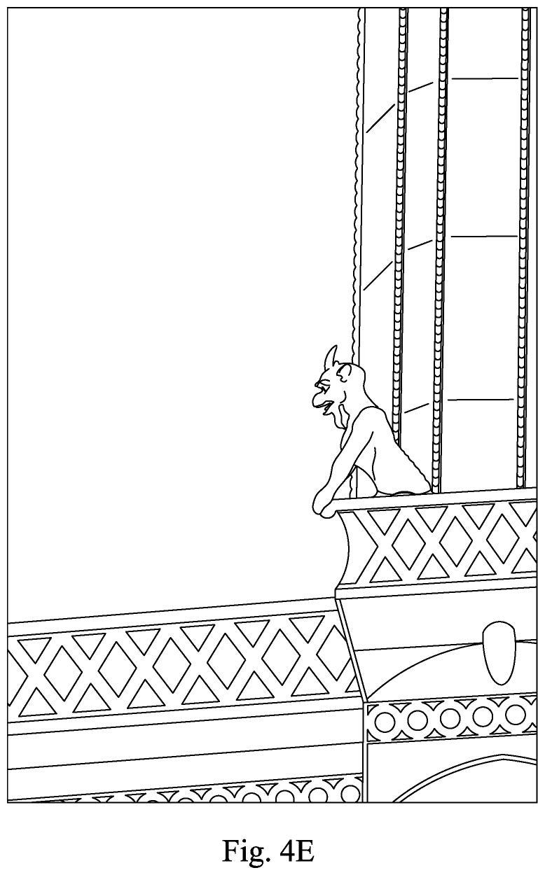

FIG. 4A is a schematic view of an electronic device 400 according to the 4th example of the present disclosure. FIG. 4B is another schematic view of the electronic device 400 according to the 4th example in FIG. 4A. In FIGS. 4A and 4B, the electronic device 400 is a smart phone, the electronic device 400 includes a plurality of camera modules and a user interface 401, wherein each of the camera modules can include the imaging lens assembly module, which can be any one of the aforementioned 1st example to the 3rd example, but the present disclosure is not limited thereto. Further, the camera modules are a high resolution camera module 410, an ultra-wide angle camera module 420 and two telephoto camera modules 430, 440, and the user interface 401 is a touch screen, but the present disclosure is not limited thereto.

Users can enter a shooting mode via the user interface 401, wherein the user interface 401 is configured to display the scene, and the shooting angle can be manually adjusted to switch the high resolution camera module 410, the ultra-wide angle camera module 420 and the telephoto camera modules 430, 440. At this moment, the imaging light is gathered on an image sensor via the camera modules, and an electronic signal about an image is output to an image signal processor (ISP) 450.

In FIG. 4A, to meet a specification of the electronic device 400, the electronic device 400 can further include an optical anti-shake mechanism (not shown). Furthermore, the electronic device 400 can further include at least one focusing assisting module (its reference numeral is omitted) and at least one sensing element (not shown). The focusing assisting module can be a flash module for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera modules of the electronic device 400 equipped with an auto-focusing mechanism and the optical anti-shake mechanism can be enhanced to achieve the superior image quality. Furthermore, the electronic device 400 according to the present disclosure can have a capturing function with multiple modes, such as taking optimized selfies, high dynamic range (HDR) under a low light condition, 4K resolution recording and so on. Furthermore, the users can visually see a captured image of the camera through the user interface 401 and manually operate the view finding range on the user interface 401 to achieve the autofocus function of what you see is what you get.

Moreover, the camera modules, the optical anti-shake mechanism, the sensing element and the focusing assisting module can be disposed on a flexible printed circuit board (FPC) (not shown) and electrically connected to the associated components, such as the image signal processor 450, via a connector (not shown) to perform a capturing process. Since the current electronic devices, such as smart phones, have a tendency of being compact, the way of firstly disposing the camera modules and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the camera modules can also be controlled more flexibly via the touch screen of the electronic device. According to the 4th example, the electronic device 400 can include a plurality of sensing elements and a plurality of focusing assisting modules. The sensing elements and the focusing assisting modules are disposed on the flexible printed circuit board and at least one other flexible printed circuit board (not shown) and electrically connected to the associated components, such as the image signal processor 450, via corresponding connectors to perform the capturing process. In other examples (not shown herein), the sensing elements and the focusing assisting modules can also be disposed on the main board of the electronic device or carrier boards of other types according to requirements of the mechanical design and the circuit layout.

Furthermore, the electronic device 400 can further include, but not be limited to, a display, a control unit, a storage unit, a random access memory (RAM), a read-only memory (ROM), or the combination thereof.

FIG. 4C is a schematic view of an image captured via the electronic device 400 according to the 4th example in FIG. 4A. In FIG. 4C, the larger range of the image can be captured via the ultra-wide angle camera module 420, and the ultra-wide angle camera module 420 has the function of accommodating wider range of the scene.

FIG. 4D is another schematic view of an image captured via the electronic device 400 according to the 4th example in FIG. 4A. In FIG. 4D, the image of the certain range with the high resolution can be captured via the high resolution camera module 410, and the high resolution camera module 410 has the function of the high resolution and the low deformation.

FIG. 4E is another schematic view of an image captured via the electronic device 400 according to the 4th example in FIG. 4A. In FIG. 4E, each of the telephoto camera modules 430, 440 has the enlarging function of the high magnification, and the distant image can be captured and enlarged with high magnification via the telephoto camera modules 430, 440.

In FIGS. 4C to 4E, the zooming function can be obtained via the electronic device 400, when the scene is captured via the camera modules with different focal lengths cooperated with the function of image processing.

### 5th Example

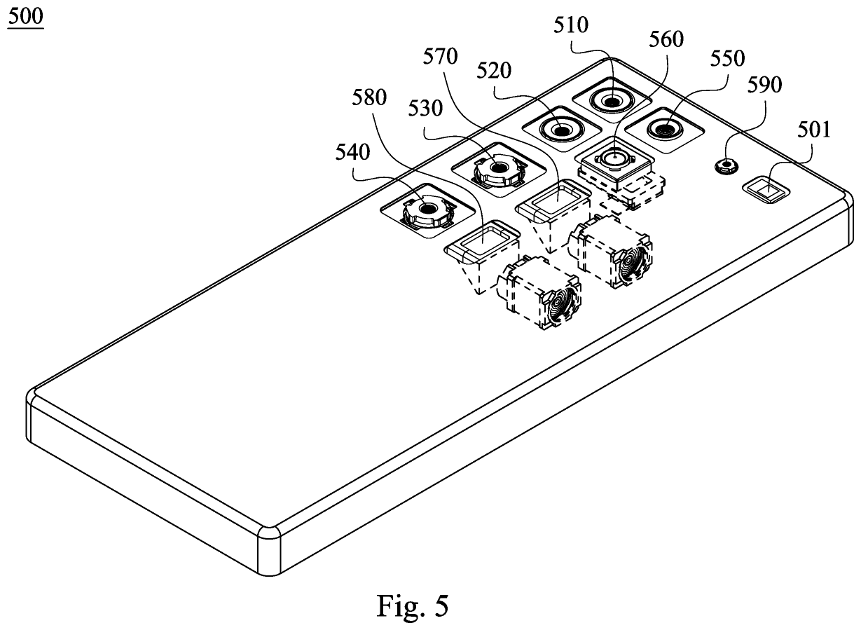

FIG. 5 is a schematic view of an electronic device 500 according to the 5th example of the present disclosure. In FIG. 5, the electronic device 500 is a smart phone, which includes a plurality of camera modules, and each of the camera modules can include the imaging lens assembly module, which can be any one of the aforementioned 1st example to the 3rd example, but the present disclosure is not limited thereto. Moreover, the camera modules can be ultra-wide angle camera modules 510, 520, wide angle camera modules 530, 540, telephoto camera modules 550, 560, 570, 580 and a Time-Of-Flight (TOF) module 590. The TOF module 590 can be another type of the camera module, and the disposition is not limited thereto.

Further, the telephoto camera modules 570, 580 are configured to fold the light, but the present disclosure is not limited thereto.

To meet a specification of the camera modules of the electronic device 500, the electronic device 500 can further include an optical anti-shake mechanism (not shown). Furthermore, the electronic device 500 can further include at least one focusing assisting module (not shown) and at least one sensing element (not shown). The focusing assisting module can be a flash module 501 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera modules of the electronic device 500 equipped with an auto-focusing mechanism and the optical anti-shake mechanism can be enhanced to achieve the superior image quality. Furthermore, the electronic device 500 according to the present disclosure can have a capturing function with multiple modes, such as taking optimized selfies, High Dynamic Range (HDR) under a low light condition, 4K Resolution recording and so on.

Further, all of other structures and dispositions according to the 5th example are the same as the structures and the dispositions according to the 4th example, and will not be described again herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An imaging lens assembly module, comprising:
an optical folding element having a reflecting surface, a light incident to the optical folding element along a first optical axis, the light exiting the optical folding element along a second optical axis after reflecting at the reflecting surface, and the first optical axis and the second optical axis intersecting at an optical axis intersection point on the reflecting surface; and
a driving module configured to drive the optical folding element to rotate, and comprising:
a first carrier disposed on a frame, the first carrier rotatable around a first rotating axis relative to the frame, and the first rotating axis vertical to the first optical axis and passing through the optical axis intersection point;
a first magnet configured to form a driving force with a first coil and drive the first carrier;
at least two first rolling elements disposed between the frame and the first carrier and configured to support the first carrier to rotate;
a second carrier disposed on the first carrier, and the optical folding element disposed on the second carrier; and
a second rolling element disposed between the first carrier and the second carrier and configured to support the second carrier to rotate;
wherein the second carrier is rotatable around a second rotating axis relative to the first carrier, and the second rotating axis is vertical to the first rotating axis.

2. The imaging lens assembly module of claim 1, wherein the at least two first rolling elements and the optical axis intersection point are coaxially disposed along the first rotating axis.

3. The imaging lens assembly module of claim 1, wherein the second rolling element and the optical axis intersection point are coaxially disposed along the second rotating axis.

4. The imaging lens assembly module of claim 1, wherein the at least two first rolling elements and the first magnet are disposed along the second rotating axis as viewed along the first rotating axis.

5. The imaging lens assembly module of claim 4, wherein the driving module further comprises:
a first yoke fixed on the frame, the first yoke and the first magnet correspondingly disposed, and the first yoke and the first magnet attracting to each other to provide a preload force to the first carrier;
wherein the at least two first rolling elements, the first magnet and the first yoke are disposed in sequence along the second rotating axis as viewed along the first rotating axis.

6. The imaging lens assembly module of claim 4, wherein the at least two first rolling elements, the second rolling element and the first magnet are disposed in sequence along the second rotating axis as viewed along the first rotating axis.

7. The imaging lens assembly module of claim 4, wherein the at least two first rolling elements are farther away from the first magnet relative to the second rolling element as viewed along the first rotating axis.

8. The imaging lens assembly module of claim 1, wherein the driving module further comprises:
at least two third rolling elements disposed between the first carrier and the second carrier and configured to support the second carrier to rotate, and the at least two third rolling elements disposed around the second rolling element as a center.

9. The imaging lens assembly module of claim 8, wherein each of the third rolling elements and the second carrier are in two-point contact.

10. The imaging lens assembly module of claim 8, wherein each of the third rolling elements and the first carrier are in three-point contact.

11. The imaging lens assembly module of claim 8, wherein a distance between each two of the at least two first rolling elements, the second rolling element and the at least two third rolling elements is fixed.

12. The imaging lens assembly module of claim 1, wherein the driving module further comprises:
a second magnet configured to drive the second carrier to rotate, wherein the second magnet has four polarities.

13. The imaging lens assembly module of claim 12, wherein the second magnet is arc-shaped, and the second magnet is centered on the first rotating axis.

14. The imaging lens assembly module of claim 1, wherein the driving module further comprises:
a second yoke disposed on the second carrier, and the second yoke and the first magnet attracting to each other to provide a preload force to the second carrier.

15. The imaging lens assembly module of claim 1, wherein the driving module further comprises:
a second yoke disposed on the second carrier, and the second yoke and a third magnet attracting to each other to provide a preload force to the second carrier.

16. The imaging lens assembly module of claim 15, wherein the second yoke is disposed in the second carrier.

17. The imaging lens assembly module of claim 1, further comprising:
a lens assembly disposed on the frame, and the lens assembly moving along the second optical axis relative to the frame.

18. The imaging lens assembly module of claim 17, further comprising:
at least two fourth rolling elements configured to support the lens assembly to move.

19. An electronic device, comprising:
the imaging lens assembly module of claim 1.
